(19) United States
(12) Patent Application Publication
(10) Pub. No.: US 2025/0094801 A1
(43) Pub. Date: Mar. 20, 2025

(54) NEURAL NETWORK CRITICAL NEURON SELECTION

(71) Applicant: Entanglement, Inc., Miami, FL (US)

(72) Inventor: Amit VERMA, Miami, FL (US)

(73) Assignee: Entanglement, Inc., Miami, FL (US)

(21) Appl. No.: 18/889,828

(22) Filed: Sep. 19, 2024

Related U.S. Application Data
(60) Provisional application No. 63/539,544, filed on Sep. 20, 2023.

(51) Int. Cl. G06N 3/08

(52) U.S. Cl. CPC G06N 3/08

(57) ABSTRACT

The present disclosure relates to systems and methods for optimizing neural networks by strategically identifying and pruning critical neurons to reduce computational resources while maintaining high levels of accuracy. The method involves determining critical neurons within a neural network based on features collected during an initial phase of training. These critical neurons are then pruned from the network, resulting in a pruned neural network with the critical neurons removed. The training process continues using the pruned neural network, allowing for significant computational savings without substantially impacting the network's performance.

### CROSS-REFERENCE TO RELATED APPLICATION

This application claims priority benefit to U.S. Provisional Patent Application No. 63/539,544, filed Sep. 20, 2023, entitled “NEURAL NETWORK CRITICAL NEURON SELECTION”, which is hereby incorporated herein by reference in its entirety.

### TECHNICAL FIELD

The present disclosure relates generally to the field of machine learning and neural networks. More particularly, it pertains to systems and methods for the strategic detection and pruning of critical neurons in neural networks, such as large language models, to achieve computational savings while maintaining high levels of accuracy.

### BACKGROUND

Artificial neural networks (ANNs) have become a foundational component of modern machine learning and artificial intelligence applications. Deep neural networks (DNNs), which consist of multiple layers of interconnected neurons, have demonstrated remarkable performance in complex tasks such as image recognition, natural language processing, speech recognition, and more. These networks are capable of learning intricate patterns and representations from large datasets.

As the demand for more sophisticated models grows, the size and complexity of neural networks have increased substantially. Large language models (LLMs), for instance, may contain billions of parameters and require vast computational resources for training and inference. The high computational cost associated with these models poses significant challenges, including prolonged training times, increased energy consumption, and the need for specialized hardware. These factors can limit the accessibility and scalability of deploying such models in real-world applications.

To address these challenges, various network compression techniques have been developed. Pruning is one such technique that aims to reduce the size of a neural network by removing less important weights or neurons. Traditional pruning methods often involve eliminating weights with small magnitudes or applying sparsity constraints to encourage weight reduction. While these methods can decrease the network size, they may not effectively identify the most critical neurons whose removal would lead to substantial computational savings without significantly impacting model accuracy.

Moreover, existing pruning approaches may not be sufficiently data driven. They often rely on static criteria that do not consider the dynamic behavior and importance of neurons during the training process. Some methods require additional computational overhead to determine which neurons or weights to prune, potentially offsetting the computational benefits achieved through pruning.

There is a need for improved systems and methods that can strategically identify and prune critical neurons in a neural network using a data-driven approach. By leveraging features collected during the early stages of training and applying techniques such as anomaly detection, it is possible to detect neurons that are critical in terms of computational cost but may have minimal impact on the model's accuracy if removed.

### SUMMARY

Systems and methods for a data-driven machine learning model that performs strategic detection and pruning of critical neurons of a neural network (e.g., applications to large language models) are disclosed herein. The disclosed examples include a strategic data-driven approach to critical neuron pruning with an overall aim of computational savings while maintaining higher levels of accuracy. For example, the disclosed examples involve identifying a set of critical neurons in the hidden layers of a neural network, given a set of input features for each neuron, and based on a subset of training data (e.g., samples of training data prior to the early stop).

In some implementations, the disclosed systems and methods include anomaly detection aspects in order to achieve the aforementioned detection of the critical neurons. Anomaly detection involves calculating a score for each neuron, where the score is based on input features of the neurons. Subsequently, the derived scores can be further evaluated to select which neurons of the neural network (in a particular hidden layer) are the critical neurons. For instance, neurons having the lowest scores (in each layer) may be identified as the critical neurons.

Finally, after anomaly detection has been employed to detect the critical neurons, the disclosed examples implement a selection or pruning of the critical neurons from the neural network. Consequently, a pruned neural network can be generated having the crucial neurons removed or pruned. The training process can be resumed using this pruned neural network (on the remaining samples of training data after the early stop), which may be a neural network that is substantively reduced in size in a manner that leads to significant savings in computational resources.

### BRIEF DESCRIPTION OF DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates a critical neuron selection or pruning system for selecting or pruning critical neurons from a neural network, in accordance with some of the embodiments disclosed herein.

FIG. 2 illustrates a neural network associated with the critical neuron selecting or pruning system, in accordance with some of the embodiments disclosed herein.

FIG. 3 illustrates a critical neuron pruning method executed by the critical neuron selecting or pruning system, in accordance with some of the embodiments disclosed herein.

FIG. 4 illustrates a critical neuron selecting or pruning method, in accordance with some of the embodiments disclosed herein.

FIG. 5 illustrates a method for determining the critical neurons in a neural network, in accordance with some of the embodiments disclosed herein.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION

Neural networks (NNs) and deep neural networks (DNNs) may be used to develop complex generative models. Much of the success of NNs and DNNs can be attributed to the number of parameters used in the models, which in turn requires enormous computational resources and typically results in excessively long training times. To reduce the computational resources required and reduce the amount of training time needed, improvements to these systems advantageously reduce the size of a NN or DNN without sacrificing the accuracy of the output.

Furthermore, NNs, which are sometimes the basis of Large Language Models (LLM), can consist of multiple layers. Generally, NNs consist of three main types of layers, including: the input layer; one or more hidden layers; and the output layer, where each of these layers respectively consist of a number of computational units called neurons. Each neuron applies a non-linear activation function on a weighted sum of inputs coming from the previous layer. The hidden layers typically use a ReLU (Rectified Linear Unit) or leaky ReLU activation function which disregards or transforms the non-positive inputs. Finally, the output layers can typically use activation functions, such as a max or softmax activation functions, depending on the number of outputs in the problem. In many instances, as the size of the training instances increase, the required computational resources utilized for training the NNs also increases.

To address these high computation issues related to NNs, the disclosed embodiments ultimately remove (also referred to herein as pruning) some neurons in the hidden layers, thereby decreasing the size of the NN and, in turn, reducing computational consumption. Identifying which particular neurons to prune and when these neurons should be pruned is a non-trivial task. Accordingly, the timing of neuron pruning is crucial. For instance, in cases where neurons are pruned too early in the NN's training process, the solution quality or accuracy of the NN can be compromised. Alternatively, pruning neurons too late during the NN's training can diminish the computational savings. According to the disclosed embodiments, pruning of critical neurons in the NN is performed at an optimized point during training, which is a defined “early stop” criterion for the NN. For example, an “early stop” parameter in the training process for the NN can be defined based on a fraction of training data. In other words, the embodiments consider a defined portion of the training data, for instance 40% of samples in the entire training data set, which is needed to train the full NN to ensure that accuracy is maintained. As a result, after this “early stop” point of training is reached (e.g., where the accuracy-based portion of training samples are used), the remaining number of samples in the training data set can be subjected to optimized training of the pruned NN, in a manner that increases computational speed and improves utilization of resources.

Also, to further maintain higher levels of accuracy, the systems and methods described herein aim to select and prune the critical neurons of NNs. Given a set of input features (based on a subset of training data prior to the “early stop” parameter) for each neuron, the disclosed embodiments can identify a set of critical neurons. Restated, the critical neurons can be identified on the basis of the features collected only during the training phase prior to the early stop. In some implementations, the disclosed embodiments utilize anomaly detection in order to calculate a score based on input features which drives the selection of critical neurons. For example, anomaly detection involves deriving feature-based scores for each neuron in a given layer, and further evaluating the scores to identify critical neurons as the neurons having the lower scores. As previously described, the critical neurons can be detected using features received from limited training data (e.g., samples in the training data set prior to the “early stop” parameter), which is useful for neuron pruning and to help speed up training processes for NNs (or LLMs). Thereafter, the identified critical neurons are pruned from the NN, and the rest of the training process continues using a reduced NN (e.g., NN with critical neurons removed), leading to significant savings in computational resources.

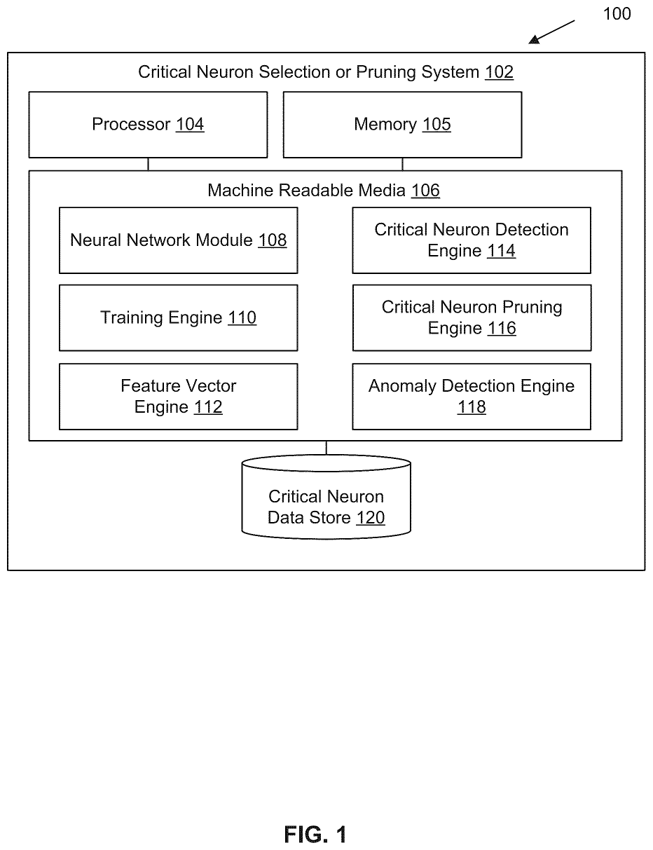

FIG. 1 illustrates a system for selecting or pruning critical neurons from a neural network, in accordance with some of the embodiments disclosed herein. In example 100, critical neuron selection or pruning system 102 is configured to determine critical neurons to select or prune in a neural network or other model using processor 104 and store data related to the critical neurons in memory 105. Critical neuron selection or pruning system 102 may be implemented as a server computer with processor 104 being an efficient processor like a graphics processing unit (GPU), although such limitations are not required with each embodiment of the disclosure.

Processor 104 may comprise a general-purpose or special-purpose processing engine such as, for example, a microprocessor, controller, or other control logic. Processor 104 may be connected to a bus, although any communication medium can be used to facilitate interaction with other components of critical neuron selection or pruning system 102 or to communicate externally.

Memory 105 may comprise random-access memory (RAM) or other dynamic memory for storing information and instructions to be executed by processor 104. Memory 105 might also be used for storing temporary variables, parameters or other intermediate information during execution of instructions to be executed by processor 104. Memory 105 may also comprise a read only memory (“ROM”) or other static storage device coupled to a bus for storing static information and instructions for processor 104.

Machine readable media 106 may comprise one or more interfaces, circuits, engines, and modules for implementing the functionality discussed herein. Machine readable media 106 may carry one or more sequences of one or more instructions processor 104 for execution. Such instructions embodied on machine readable media 106 may enable critical neuron selection or pruning system 102 to perform features or functions of the disclosed technology as discussed herein. For example, the interfaces, circuits, and modules of machine-readable media 106 may comprise, for example, neural network module 108, training engine 110, feature vector engine 112, critical neuron detection engine 114, critical neuron pruning engine 116, and anomaly detection engine 118. Critical neuron data store 120 may store information related to critical neurons and other nodes, as well as other information associated with the neural network.

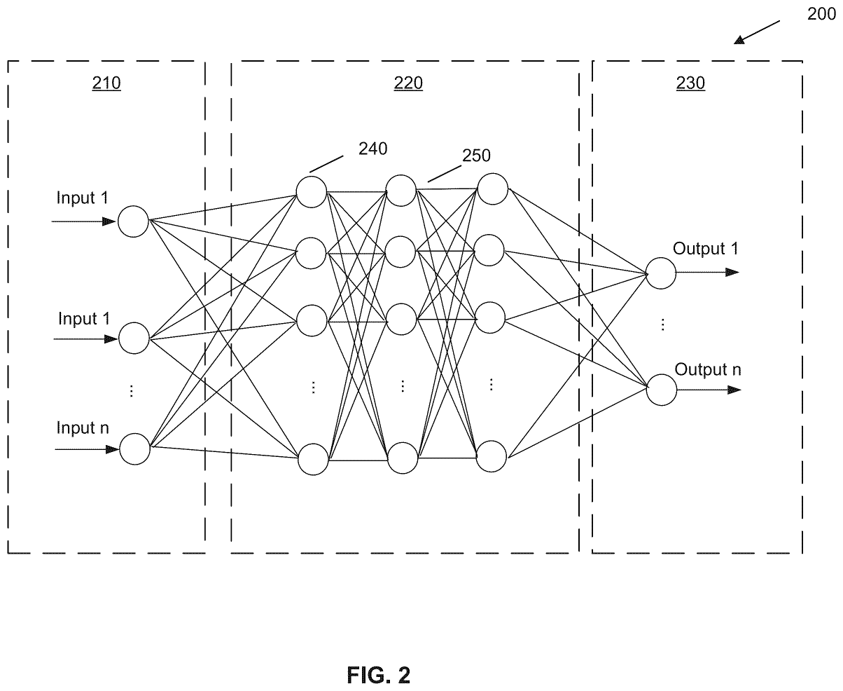

Neural network module 108 is configured to generate a neural network. An illustrative neural network is provided in FIG. 2.

Neural networks, including deep neural networks, comprise a set of processing neurons (also referred to as nodes) that are interconnected and weighted. In the context of neural networks and deep learning, neurons are also referred to as the “nodes” of a neural network, referring to the basic computational units within the neural network. Accordingly, neurons can be considered individual processing units within the neural network that receive inputs, perform computations (including weighted summation and activation), and produce an output. To train the neural network, the weights of the neurons may be initially set to random values. As training data is fed to the first layer of the neurons, the data may pass through the next layers to transform the data to the output layer. During training, the weights and thresholds of each of the neurons may be adjusted until the neural network produces similar outputs for similar training data and labels.

Training engine 110 is configured to receive an input dataset, also referred to herein as the training data. In some examples, training engine 110 is configured to train a model (M) on the input dataset (X).

Training engine 110 is configured to train the model for some set number (N₀) of iterations, which are used to gather information about the weights (W, ΔW, +params) throughout the training process. Training engine 110 is configured to train a model by performing training-related tasks including, but not limited to: initialization; forward pass; loss calculation; backpropagation; weight update; validation; testing; and the like. The training engine 110 continues the training process until a level of accuracy or performance that is deemed acceptable is achieved for the model, which allows the neural network to learn complex patterns and relationships within the data, making the model capable of making predictions and classifications on new (or unseen) data. According to the embodiments, the training engine 110 is configured to train a full neural network utilizing the portion of the training data set prior to the “early stop” parameter, and subsequently continue the training process using the pruned neural network (including the pruned critical neurons) with the remaining portion of the training data.

Feature vector engine 112 is configured to generate feature vectors for each neuron in the neural network. Feature vector engine 112 can parse a layer of the neural network, for instance a hidden layer, and create a feature vector for each neuron in that layer. A feature vector is a representation of several features that are received in the input data that is associated with the particular neuron. For example, a feature vector for a neuron can be represented as:

$${FV}_{i} = {( f 1 , f 2 , f 3 , f 4 , f 5 a , f 5 b , f 5 c , f 5 d , f 6 a , f 6 b )}_{i} \qquad ( 1 )$$

where i is the index to a layer

Feature vector engine 112 is also configured to perform calculations and evaluations necessary to derive a set of features for neurons. In an embodiment, feature vector engine 112 analyzes training data to create a set of features for a neuron, including at least six features: 1) Neuron Coverage (NC); 2) Strong Neuron Coverage (SNAC); 3) K-Multisection Neuron Coverage (KMNC); 4) Top-K Neuron Coverage (TKNC); 5) Modified Condition/Decision Coverage (MC/DC); and 6) Weight Adjustments. This set of features is represented in the feature vector that is examined to determine whether the neuron is critical. All of these features (1-6) are collected for each neuron (i) in a specific layer (l) of the neural network, using only the portion of the training data received prior to the defined early stop point. As will be described in greater detail herein, the feature vectors generated by feature vector engine 112 are particularly employed by the anomaly detection techniques to generate scores and ultimately identify each neuron as critical or non-critical.

Critical neuron detection engine 114 is configured to detect, or otherwise identify, the critical neurons in the neural network. Critical neuron detection engine 114 can function during the training process for a model, particularly upon reaching the early stop portion of training data. In some implementations, critical neuron detection engine 114 detects the critical neurons within each of the hidden layers of the neural network, respectively. For example, critical neuron detection engine 114 evaluates a particular hidden layer (l) of a neural network, and then further evaluates each of the total number of neurons in that layer (Nₗ) to identify whether a specific neuron is critical is non-critical, based on the neuron's corresponding features. Accordingly, critical neuron detection engine 114 can identify a set of all of the critical neurons for a given layer.

Critical neuron pruning engine 116 is configured to prune the detected critical neurons. Subsequent to detecting the critical neurons within the neural network, for instance by critical neuron detection engine 114, these critical neurons are pruned from its layers by critical neuron pruning engine 116. For example, the critical neuron pruning engine 116 can remove all of the identified neurons from each specific hidden layer, until all of the critical neurons have been pruned from the neural network. Thus, the critical neuron pruning engine 116 can be additionally configured to update the model (M) based on the pruned critical neurons. In some examples, critical neuron pruning engine 116 is configured to automatically update the model upon implementing the critical neuron pruning process executed. A pruned neural network model (corresponding with the updated model) may have fewer neurons, and non-zero connections between neurons. With fewer neurons, and non-zero connections between neurons, fewer computations may be needed during both additional training phases and the inference phase after critical neurons have been removed.

In some implementations, a pruning rate is a parameter received by critical neuron selection or pruning system 102 that is then utilized by the critical neuron pruning engine 116 to determine a specific number of critical neurons that are removed in a specific layer. The prune rate can be expressed as a mathematical or numerical representation. As an example, the prune rate may be defined as a percentage (e.g., 10%, 20%, 25%, etc.) that is based on the total number of neurons in a layer l. Thus, in this case, a number of pruned neurons (P) can be determined by multiplying the pruning rate (p) by the total number of neurons in the given layer (Nₗ). In some examples, the number or percentage of critical neurons to prune (prune rate) may be a variable or fixed at a particular value, both determined by a user of critical neuron selection or pruning system 102. In some examples, the process may not allow for choosing how many critical neurons to prune. The number of neurons to be pruned may be decided or set by the given pruning rate. Therefore, critical neuron pruning engine 116 can generate a pruned neural network that is reduced in comparison to the initial full neural network, due to the pruning of the critical neurons. Pruning a critical neuron can also involve removing the components of that neuron, such as the input weights, activation function, and output, thereby eliminating data and computations associated with that neuron from the neural network. The rest of the training process is continued using the pruned neural network, which leads to significant savings in computational resources. In some examples, the pruning rate (indicating number or percentage of critical neurons to prune) may be fixed at a particular value. In some examples, the process may not allow for choosing how many critical neurons to prune.

In some implementations, the critical neuron pruning engine 116 is configured to implement critical neuron pruning globally or layer-wise. In some examples, an administrative user may select global or layer-wise critical neuron pruning. Systems and methods described herein may perform layer-wise pruning but can be applied to global pruning as well.

Anomaly detection engine 118 is configured to implement anomaly detection, which is a specific technique that can be applied to identify the critical neurons of the neural network using a score-based approach. Anomaly detection engine 118 determines which neurons are the critical neurons based on collected features. The anomaly detection techniques will be described in greater detail herein. Generally, in implementing anomaly detection, anomaly detection engine 118 generates a score for each neuron in a given layer using their corresponding feature vector (generated by feature vector engine 112), and then identifies the critical neurons by determining which neurons have the lowest calculated score in the layer. In some implementations, the feature vector for a neuron is initially normalized, for example being normalized to the range [0,1]. Subsequently, the features collected during the first portion of the training process (e.g., training data prior to the early stop point) are analyzed to calculate an average of each neuron's feature vector, which is then used to derive a score for each neuron, respectively.

Accordingly, anomaly detection engine 118 generates a separate score for each neuron in a particular layer (e.g., iterative for all of the hidden layers in the neural network), where the score is then evaluated to determine whether the neuron is a critical neuron. In some examples, anomaly detection engine 118 executes a comparison of the scores within a specific layer, in order to determine a set of scores that are the lowest in that layer. The neurons corresponding to these lowest scores in the set, are deemed the critical neurons within the layer. Alternatively, anomaly detection engine 118 may compare the calculated scores to a set value that is predetermined to be indicative of a critical neuron, for instance a critical neuron score threshold, in order to select a set of scores that are lower than the set value, and ultimately determine the critical neurons.

Consequently, by implementing the distinct detection and pruning of the critical neurons in an optimal stage of the training process, the system disclosed herein achieves a high level of accuracy, while realizing substantial computational consumption for the neural network.

FIG. 2 illustrates a neural network associated with the critical neuron pruning system, in accordance with some of the embodiments disclosed herein. In example 200, the neural network may comprise input layer 210, hidden layers 220, and output layer 230. Each of these layers may comprise a set of nodes, referred to herein as neurons, including neuron 240, and weights between the nodes, including weight 250.

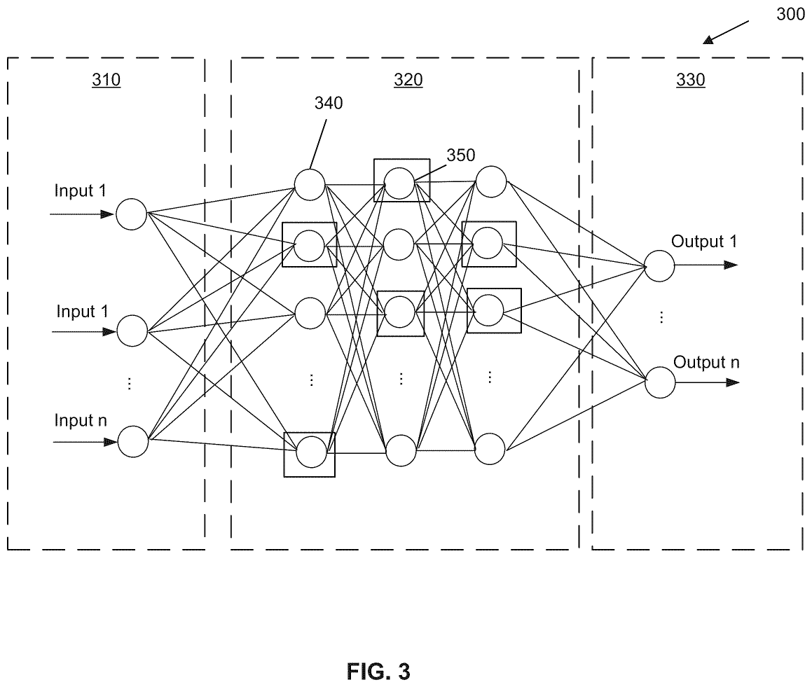

FIG. 3 illustrates a critical neuron pruning method executed by the critical neuron selection or pruning system 102 shown in FIG. 1, in accordance with some of the embodiments disclosed herein. Similar to the initial (of full) neural network displayed in FIG. 2, the neural network 300 comprises an input layer 310, hidden layers 320, and output layer 330. Each of these layers comprise neurons, including neuron 340, and weights between the nodes, including weight 350.

In example 300, critical neuron selection or pruning system 102 illustrated in FIG. 1 may initiate the critical neuron pruning method on the initial neural network shown in FIG. 2. FIG. 3 serves to illustrate that the system identifies a subset of neurons within the hidden layer 320 as critical neurons, including critical neuron 350. Accordingly, the critical neurons can be removed, or otherwise pruned, from the neural network. As seen in FIG. 3, the pruned critical neurons are depicted as being bound in boxes, which indicates removing these neurons from their respective layers (and some corresponding weights) upon executing the critical neuron pruning method described herein. Thus, the neural network in FIG. 3 depicts a resulting pruned network, where neurons have been deemed as critical neurons and removed. Generally, the pruned neural network in FIG. 3, which has been subjected to the critical neuron pruning method is reduced in comparison to the neural network in FIG. 2 (e.g., having fewer nodes and weights). As a result, the pruned neural network of FIG. 3 may be optimized for training, involving less computations and utilizing fewer computational resources.

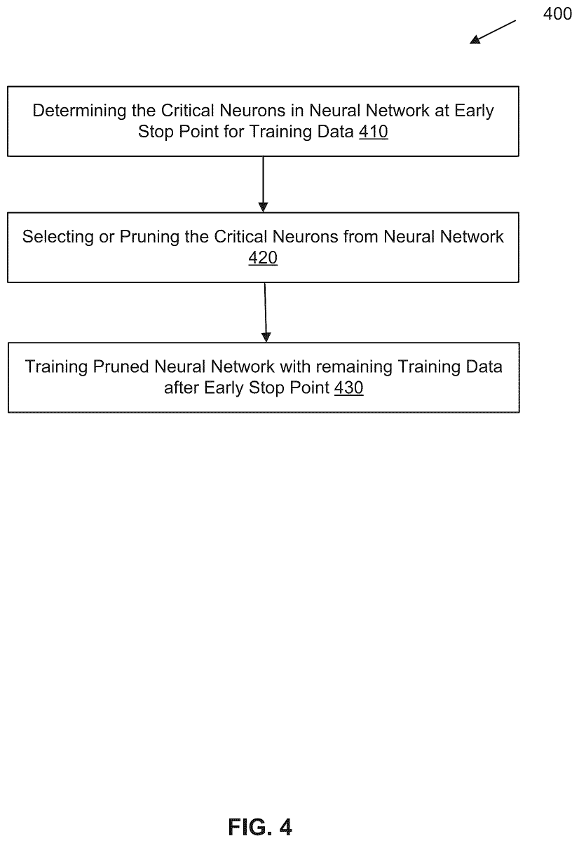

FIG. 4 illustrates a critical neuron pruning method, in accordance with some of the embodiments disclosed herein. For example, critical neuron selection or pruning system 102 illustrated in FIG. 1 may execute machine readable instructions by processor 104 to perform the functions described herein.

At block 410, the critical neurons are determined at a defined early stop point during the training process of a full neural network (e.g., initial neural network prior to pruning). In some implementations, the early stop point can be defined by the system (or entered into the system by a user) as some fraction of training samples in the training dataset. For example, the stop point can be set by the system as a percentage (e.g., 50%) of training samples in the training data set. Continuing with this example, as samples from the training data are received by the neural network as an input data set during the initial training stages, the system can begin the actions at block 410 to identify which neurons are critical neurons after 50% of the training samples have been encountered in training the initial full neural network.

Block 410 can involve applying a model to detect the critical neurons based on observed data, namely features collected from the input data set. For a neural network that has a specific number of (L) hidden layers, the method can iteratively detect the critical neurons in each of the (L) layers. For example, each neuron in a specific layer can be individually indexed (i), where each layer is represented as the following formula:

$$l = ∈ 1 , … L \qquad ( 2 )$$

where l is an individual layer, and
L is the total number of hidden layers.

Various features can be analyzed in block 410 to determine which neurons are the critical neurons at the layer-level. Features can include forward propagation-based features, and back propagation-based features. Neuron Coverage (NC) is a forward propagation-based feature that may be analyzed at block 410. NC feature can be described as a proportion of training samples where the neuron activation value a(l,i) is larger than 0 (or some specified threshold). In other words, NC is a metric that measures how often a particular neuron is activated during the training process. Neurons with low NC may be less frequently activated and contribute less to the network's output.

Another forward propagation-based feature that may be analyzed by block 410 is Strong Neuron Activation Coverage (SNAC). SNAC measures the proportion of training samples where a neuron's activation exceeds a predefined high threshold, indicating how often a neuron is strongly activated during the training process. Neurons with low SNAC values are rarely strongly activated and may have minimal impact on the network's output. Such neurons are candidates for pruning because their removal is unlikely to significantly affect the network's performance. SNAC can be described as a proportion of training samples having a neuron activation that is represented as the following formula:

$$\{ a ( l , i ) > high ( l , i ) ; 1 \leq l \leq L \} \qquad ( 3 )$$

where a(l, i) is the neuron activation value for neuron i in layer l and high(l, i) is a high activation threshold specific to layer l.

K-multisection Neuron Coverage (KMNC) is also a forward propagation-based feature that may be analyzed by block 410. KMNC divides a neuron's activation range between high(l,i) (maximum activation value observed for neuron i i in layer l l across used training samples) and low(l,i) (minimum activation value for the same neuron) into K equivalent sections, each denoted by range(l, i, k). KMNC measures how thoroughly a neuron utilizes its activation range during training. It can identify neurons that do not fully exploit their activation potential, indicating they may contribute less to the network's learning process. Pruning such neurons can reduce the network's complexity without significantly affecting performance. KMNC can be described as a proportion of training samples having a neuron activation that is represented as the following formula:

$$\{ ( a ( l , i ) IN range ( l , i , k ) ; 1 \leq l \leq L , 1 \leq k \leq K \}$$

where a(l, i) refers to activation of neuron i in layer l, range(l, i, k) refers to the k-th interval or section of the activation range for neuron i in layer l, 1≤l≤L means the KMNC applies to all layers from the first to the last layer L, and 1<=k<=K means the analysis applies to all sections.

Additionally, block 410 may involve analyzing Top-K Neuron Coverage (TKNC), which is a forward propagation-based feature. TKNC can be described as the proportion of training samples where a neuron activation value occurs to be one of the most active K neurons at its layer. TKNC can be used to identify neurons that rarely contribute significantly to the layer's output. Neurons with low TKNC values are considered less critical and may be pruned to simplify the network. TKNC may be represented as the following formula:

$$\{ a ( l , i ) IN top ( k , L ) ; 1 \leq l \leq L \} \qquad ( 4 )$$

a(l, i): The activation value of neuron i in layer l.
top(k, L): The set of top K activation values in layer l for a given training sample.

Modified Condition/Decision Coverage (MC/DC) is another forward propagation-based feature that may be analyzed by block 410. MC/DC considers the relation between neuron activations at two adjacent layers, such that each neuron at layer l (condition) independently impacts the connected neuron activation at layer l+1 (decision). Thus, the interactions between neurons at layers l and l+1 can be defined. For example, the interactions can be defined based on Signal (S) and Value (V). The signal S is binary data type while the value V is a continuous data type. There may be four types of interaction variables observed, based on the interactions between neuron i at layer l and neuron j at layer l+1. The activation value can be compared against a threshold to determine whether a neuron is active. In accordance with MC/DC, SS can be given by I/O binary attribute, represented as the following formula:

$$\{ ( a ( l , i ) > threshold ) * ( a ( l + 1 , j ) > threshold ) \} \qquad ( 5 )$$

In accordance with MC/DC, SV can be defined by a numerical attribute, represented as the following formula:

$$\{ ( a ( l , i ) > threshold ) * ( a ( l + 1 , j ) ) \} \qquad ( 6 )$$

In accordance with MC/DC, the VS can be defined by a numerical attribute represented as the following formula:

$$\{ ( a ( l , i ) * ( a ( l + 1 , j ) > threshold ) \} \qquad ( 7 )$$

In accordance with MC/DC, the VV can defined by a numerical attribute that is represented as the following formula:

$$\{ ( a ( l , i ) ) * ( a ( l + 1 , j ) \} \qquad ( 8 )$$

Furthermore, block 410 may involve analyzing weight adjustments, which is a backpropagation-based feature. Weight adjustments (deltas) for each neuron over the training samples (while backpropagation) can be described by a time series and its attributes can be captured through its mean and/or standard deviation. Backpropagation can happen at the end of every batch after losses are cumulatively computed. Hence, in some examples, backpropagation-based features (relying on gradients) could be weighted differently than forward propagation-based features.

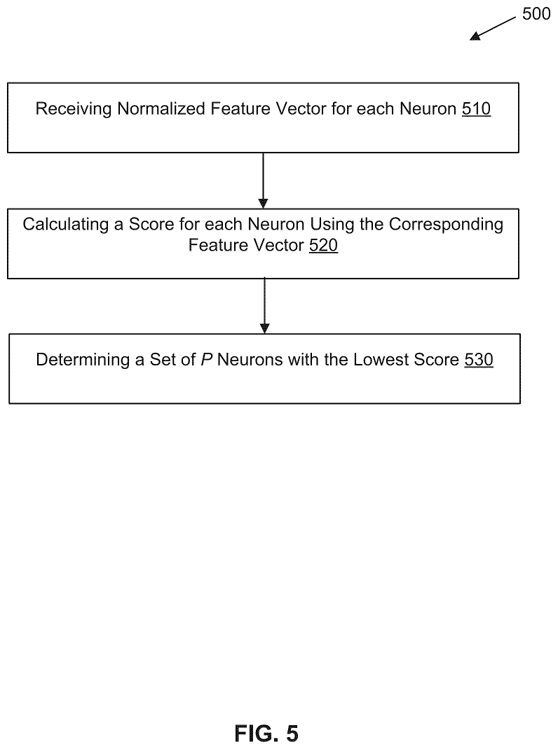

Consequently, block 410 may involve analysis of the aforementioned features, which are collected for each neuron i in a specific layer l during the training phase prior to the early stop parameter. In some implementations, block 410 involves employing the anomaly detection method, which generates scores for neurons based on input features which will drive the selection of critical neurons as described in greater detail in reference to FIG. 5.

At block 420, the critical neurons (determined in previous block 410) are selected or pruned from the neural network. In some implementations, a particular number of critical neurons that is pruned may be further based on a pruning rate provided by the user. As an example, the system can receive a pruning rate which indicates that 25% of detected critical neurons should be removed from a particular layer. Thus, continuing with the example, in a case where 100 critical neurons are detected in a layer in previous block 410, then block 420 would prune 25 of those critical neurons from the layer. Alternatively, the pruning rate can be a value or percentage that is determined automatically by the system. In some implementations, block 420 can operate independent of a pruning rate parameter and prune all (or a predetermined number) of the detected critical neurons from the neural network, when deemed necessary and/or appropriate. Block 420 can also involve removing data, weights, activation functions, and the like that are associated with each pruned neuron from the neural network. As a result, block 420 generates a pruned neural network that has been substantively reduced in size and computations as compared the initial full neural network (being trained before the early stop point).

Subsequently, at block 430, training process is continued using the pruned neural network, which has the critical neuron removed. That is, block 430 performs the later training phases using the smaller pruned neural network, where the remaining training data after the early stop point is employed. Returning back to the example discussed for block 410, in a case where a 50% early stop point is set by the system as 50%, the later training phases (after pruning) would be completed by applying the remaining 50% of the training data to the pruned neural network. Consequently, the critical neuron pruning method ultimately utilizes the total number of samples included the training data set, training the full initial neural network using a portion of the samples (before the early stop point) and training the pruned neural network with the other portion of samples in the data set (after the early stop point). It should be understood that subsequent to training the neural network in block 430, the neural network and models can be applied for inference, which also may realize benefits from pruned neural net.

FIG. 5 illustrates an anomaly detection method, in accordance with some of the embodiments disclosed herein. For example, critical neuron selection or pruning system 102 illustrated in FIG. 1 may execute machine readable instructions by processor 104 to perform the functions described herein. The anomaly detection method can be generally described as creating a score for each neuron, given a set of input features for the neurons, where it is the values of the scores that governs the selection of critical neurons.

At block 510, a normalized feature vector for each neuron within a layer is received. For example, features (e.g., feature 1-feature 6) are collected for each neuron (i) in a specific layer (l) during the samples in the training data set received prior to the early drop point. These features are normalized and fed into the anomaly detection method. A feature vector FV for a neuron can be represented by the feature vector (f1, f2, f3, f4, f5a, f5b, f5c, f5d, f6a, f6b). Additionally, in some embodiments, each received feature vector is normalized to the range [0,1].

At block 520, the feature vectors are used to calculate a score for each neuron within a given layer. That is, the collected features are used to compute a score, where an average of the feature vector for each neuron is used to derive the score. The relationship between a feature vector for a neuron and its corresponding score can be represented in programming code as:

$$\begin{matrix}for i ∈ ( 1 , 2 … {N}_{l} ) \\ {score}_{i} = ( f 1 + f 2 + … + f 6 b ) / 10\end{matrix} \qquad ( 9 )$$

At block 530, a number (P) of neurons having the lowest score are part of the critical neuron set C. The number of pruned neurons in a specific layer (l) is based on a pruning rate (p) (e.g., 10%, 20%, etc.) and the total number of neurons in the specific layer Nₗ. For example, if the system receives a defined pruning rate (p) of 10% and there are 200 total neurons in a particular layer, then block 530 would create a set of critical neurons for the layer that includes exactly 20 neurons (neurons having the lowest calculated scores). In some examples, if the system receives a defined pruning rate (p) of 10% and there are 200 total neurons in a particular layer, then block 530 would create a set of critical neurons for the layer that includes more or less than 20 neurons (neurons having the lowest calculated scores). In some examples, the pruning rate (p) can be entered into the system as a user defined parameter. Alternatively, the pruning rate can be a value or percentage that is determined automatically by the system.

Accordingly, block 530 can select P neurons from a layer having the lowest scores (calculated in previous block 520) as part of the critical neuron set (C). Selecting the critical neurons within a layer based on the calculated score, in accordance with the anomaly detection method, can be represented as the following formula:

$$C = i ∈ ( 1 , 2 , … {N}_{l} ) such that {score}_{i} \leq threshold \qquad ( 10 )$$

where threshold=Pₜₕ lowest score

The anomaly detection method strategically identifies the critical neurons to be pruned from a neural network layer, which is based on input features observed in data prior to the early stop point. In some embodiments, the anomaly detection method can incorporate more complex routines using high dimensional outlier detection and clustering-based distance measures. Furthermore, after the anomaly detection method competes, and critical neurons have been detected throughout the hidden layers of the neural network, the critical neurons are removed from the neural network in a manner leads to significant savings in computational resources.

The processes may be implemented by a computer system. The computer system may include a bus or other communication mechanism for communicating information, one or more hardware processors coupled with the bus for processing information. The hardware processor(s) may be, for example, one or more general purpose microprocessors.

The computer system also includes a main memory, such as a random-access memory (RAM), cache and/or other dynamic storage devices, coupled to the bus for storing information and instructions to be executed by the processor. The main memory also may be used for storing temporary variables or other intermediate information during execution of instructions to be executed by the processor. Such instructions, when stored in storage media accessible to the processor, render the computer system into a special-purpose machine that is customized to perform the operations specified in the instructions.

The computer system further includes a read only memory (ROM) or other static storage device coupled to the bus for storing static information and instructions for the processor. A storage device, such as a magnetic disk, optical disk, or thumb drive, may be coupled to the bus for storing information and instructions.

The computer system may be coupled via the bus to a display, such as a liquid crystal display (LCD), for displaying information to a computer user. An input device, including alphanumeric and other keys, is coupled to the bus for communicating information and command selections to the processor. Another type of user input device is a mouse, a trackball, or cursor direction keys for communicating direction information and command selections to the processor and for controlling cursor movement on the display. In some embodiments, the same direction information and command selections as cursor control may be implemented via receiving touches on a touch screen without a cursor.

The computing system may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system may implement the techniques described herein using customized hard-wired logic, one or more ASICs or FPGAs, firmware and/or program logic which in combination with the computer system causes or programs the computer system to be a special-purpose machine. According to one embodiment, the techniques herein are performed by the computer system in response to the processor(s) executing one or more sequences of one or more instructions contained in the main memory. Such instructions may be read into the main memory from another storage medium. Execution of the sequences of instructions contained in the main memory causes the processor(s) to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks. Volatile media includes dynamic memory. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise a bus. Transmission media can also take the form of acoustic or light waves, such as those generated during radio-wave and infra-red data communications.

The computer system also includes a communication interface coupled to the bus. The interface provides a two-way data communication coupling to one or more network links that are connected to one or more local networks. For example, the interface may be an integrated services digital network (ISDN) card, cable modem, satellite modem, or a modem to provide a data communication connection to a corresponding type of telephone line. As another example, the interface may be a local area network (LAN) card to provide a data communication connection to a compatible LAN (or WAN component to communicated with a WAN). Wireless links may also be implemented. In any such implementation, the interface sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the worldwide packet data communication network now commonly referred to as the “Internet.” Local network and Internet both use electrical, electromagnetic or optical signals that carry digital data streams. The signals through the various networks and the signals on network link and through an interface, which carry the digital data to and from the computer system, are example forms of transmission media.

The computer system can send messages and receive data, including program code, through the network(s), network link and interface. In the Internet example, a server might transmit a requested code for an application program through the Internet, the ISP, the local network and the interface.

The received code may be executed by the processor as it is received, and/or stored in the storage device, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method comprising:
determining critical neurons in a neural network;
pruning the critical neurons from the neural network, wherein the pruning generates a pruned neural network with the critical neurons removed; and
continuing a training process using the pruned neural network.

2. The method of claim 1, further comprising determining an early stop point during the training of the neural network.

3. The method of claim 2, wherein the early stop point comprises a subset of a training data set.

4. The method of claim 3, wherein initial phases of the training process train the neural network using the subset of training data before the early stop point.

5. The method of claim 3, wherein continuing the training process comprises training the neural network using a remaining subset of training data after the early stop point.

6. The method of claim 1, wherein the pruning of the critical neurons is implemented globally.

7. The method of claim 1, wherein the pruning of the critical neurons is implemented layer-wise.

8. A critical neuron pruning system comprising:
a memory; and
a processor that is configured to execute machine readable instructions stored in the memory for causing the processor to:
determine critical neurons in a neural network;
prune the critical neurons from the neural network, wherein the pruning generates a pruned neural network with the critical neurons removed; and
continue a training process using the pruned neural network.

9. The critical neuron pruning system of claim 8, wherein the system receives a pruning rate parameter.

10. The critical neuron pruning system of claim 9, wherein the system determines a number of critical neurons for a layer of the network based on the pruning rate parameter and a total number of neurons in the layer.

11. The critical neuron pruning system of claim 8, wherein the pruning comprises removing the number of critical neurons from the layer and weights associated with the critical neurons from the layer.

12. The critical neuron pruning system of claim 8, wherein the critical neurons are determined based on features associated with each neuron comprising forward propagation-based features and back propagation-based features.

13. The critical neuron pruning system of claim 8, wherein the weight pruning is implemented layer-wise.

14. A method, comprising:
receiving a normalized feature vector corresponding to each neuron in a layer of a neural network;
calculating a score for each neuron in the layer, wherein the score is based on the normalized feature vector and features collected during training of the neural network; and
determining a set of neurons having a score lower than a threshold, wherein the neurons in the set of neurons are identified as critical neurons.

15. The method of claim 14, further comprising:
receiving a pruning rate parameter.

16. The method of claim 15, further comprising:
determining a number of critical neurons for a layer of the network based on the pruning rate parameter and a total number of neurons in the layer.

17. The method of claim 14, further comprising:
pruning the critical neurons from the neural network, wherein the pruning generates a pruned neural network with the critical neurons removed.

18. The method of claim 17, wherein the pruning comprises removing the number of critical neurons from the layer and weights associated with the critical neurons from the layer.

19. The method of claim 17, wherein the pruning of the critical neurons is implemented layer-wise.

20. The method of claim 17, wherein the pruning of the critical neurons is implemented globally.
